(19) United States
(12) Patent Application Publication
(10) Pub. No.: US 2007/0150750 A1
(43) Pub. Date: Jun. 28, 2007

(54) Information processing apparatus and access control method

(75) Inventor: Tomoyuki Kokubun, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/593,535

(22) Filed: Nov. 7, 2006

(30) Foreign Application Priority Data
Dec. 26, 2005 (JP) 2005-373352

(51) Int. Cl. G06F 12/14

(52) U.S. Cl. 713/189

(57) ABSTRACT

According to one embodiment, there is provided an information processing apparatus including a storage unit which stores an encrypted data file and an executable file to execute the data file, a processing unit which stores a value generated by computing information of the executable file in a storage area, and a control unit which determines whether a value generated by computing information of an executable file indicated by a request for access to the data file stored in the storage unit coincides with the value stored in the storage area, and blocks access to the data file when both the values do not coincide with each other.

### CROSS-REFERENCE TO RELATED APPLICATIONS

This application is based upon and claims the benefit of priority from Japanese Patent Application No. 2005-373352, filed Dec. 26, 2005, the entire contents of which are incorporated herein by reference.

### BACKGROUND

1. Field

One embodiment of the invention relates to an information processing apparatus having a function of protecting files against unauthorized access, an access control method, and a storage medium.

2. Description of the Related Art

There is a method of protecting files safely in an information processing apparatus such as a personal computer (PC). In this method, when a target file is encrypted/decrypted, its authentication is performed by user's password, fingerprint, signature, or the like.

When a file is encrypted and stored in a storage (which exists physically or which serves virtually as a drive), a user is generally authenticated when a first request for access to the storage is made. For example, in order to close a file, authentication for closing the file is performed or a PC is shut down.

Jpn. Pat. Appln. KOKAI Publication 2001-337864 discloses a technique of permitting access to a specific file so long as a specific user uses a specific program.

According to the prior art technique, however, a user can gain access to a file without limitation through a program that is running under user log-on environment after authentication is performed. Such a state is open to spyware and external hacking (through a fire wall and a shared hole of the storage).

### BRIEF DESCRIPTION OF THE SEVERAL VIEWS OF THE DRAWING

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of a computer according to an embodiment of the invention, the display unit of which is open;

FIG. 2 is an exemplary block diagram showing a system configuration of the computer according to the embodiment of the invention;

FIG. 3 is an exemplary block diagram showing a basic configuration for controlling a request for access to a file which is made in the computer according to the embodiment of the invention;

FIG. 4 is an exemplary block diagram showing a first example of the encryption/decryption program shown in FIG. 3;

FIG. 5 is an exemplary block diagram showing a second example of the encryption/decryption program shown in FIG. 3;

FIG. 6 is an exemplary block diagram illustrating the access processing unit shown in FIG. 5 in detail;

FIG. 7 is an exemplary chart showing an example of the items of an extension/executable file correspondence table (first table) shown in FIG. 6;

FIG. 8 is an exemplary chart showing an example of the items of an executable file/hash value correspondence table (second table) shown in FIG. 6; and

FIG. 9 is an exemplary flowchart showing an operation of the access processing unit shown in FIG. 6.

### DETAILED DESCRIPTION

Various embodiments according to the invention will be described hereinafter with reference to the accompanying drawings. In general, according to one embodiment of the invention, there is provided an information processing apparatus including a storage unit which stores an encrypted data file and an executable file to execute the data file, a processing unit which stores a value generated by computing information of the executable file in a storage area, and a control unit which determines whether a value generated by computing information of an executable file indicated by a request for access to the data file stored in the storage unit coincides with the value stored in the storage area, and blocks access to the data file when both the values do not coincide with each other.

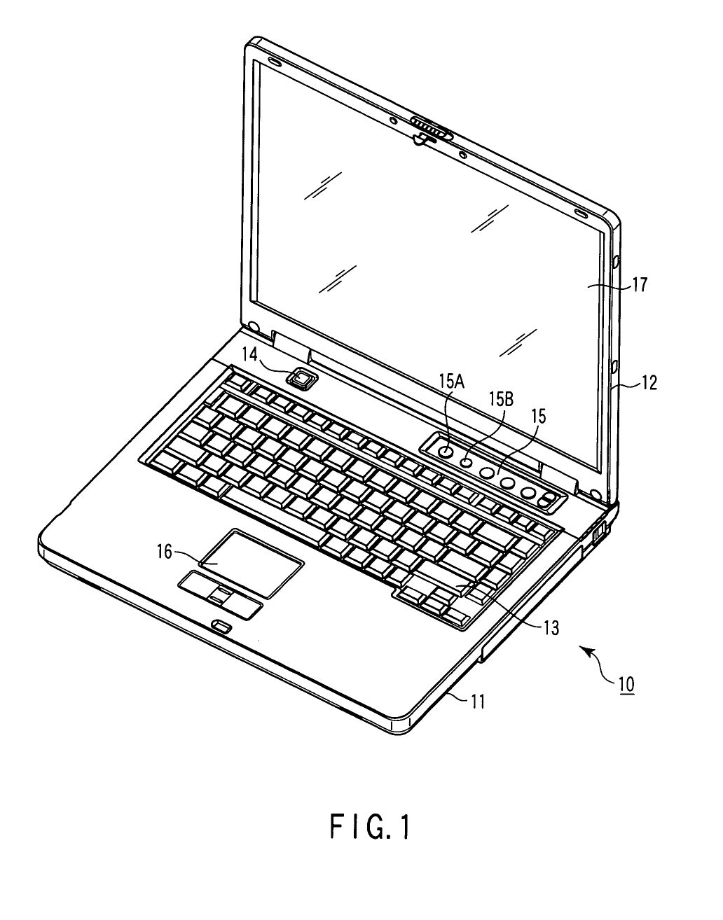

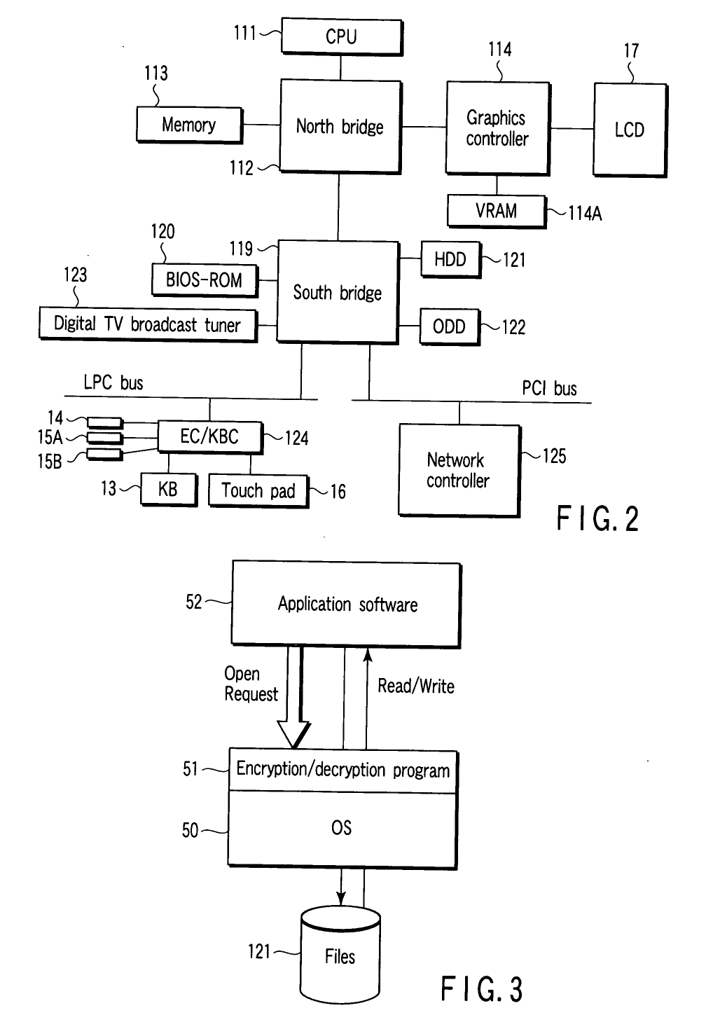

Referring first to FIGS. 1 and 2, the configuration of an information processing apparatus according to the embodiment of the invention will be described. The information processing apparatus is implemented as a notebook personal computer 10.

FIG. 1 is a perspective view of the notebook personal computer 10 whose display unit is open. The computer 10 includes a main body 11 and a display unit 12. The display unit 12 incorporates a display device having a liquid crystal display (LCD) 17. The display screen of the LCD 17 is located in almost the central part of the display unit 12.

The display unit 12 is attached to the main body 11 such that it can freely turn between its open position and closed position. The main body 11 has a thin box-shaped housing. A keyboard 13, a power button 14, an input operation panel 15 and a touch pad 16 are arranged on the top surface of the main body 11. The power button 14 is used to power on/power off the computer 10.

The input operation panel 15 is an input device for inputting an event corresponding to a depressed button. The panel 15 includes a plurality of buttons for starting a plurality of functions. These buttons include a television (TV) start button 15A and a digital versatile disc (DVD) start button 15B. The TV start button 15A is a button for starting a TV function of recording and playing back broadcast program data such as digital TV broadcast programs. When a user depresses the TV start button 15A, an application program for performing a TV function starts automatically. The DVD start button 15B is a button for playing back video contents stored in a DVD. When a user depresses the DVD start button 15B, an application program for playing back a video content starts automatically.

The system configuration of the computer 10 will be described with reference to FIG. 2.

Referring to FIG. 2, the computer 10 includes a CPU 111, a north bridge 112, a main memory 113, a graphics controller 114, a south bridge 119, a BIOS-ROM 120, a hard disk drive (HDD) 121, an optical disk drive (ODD) 122, a digital TV broadcast tuner 123, an embedded controller/keyboard controller IC (EC/KBC) 124 and a network controller 125.

The CPU 111 is a processor for controlling an operation of the computer 10. The CPU 111 executes an operating system (OS), a file system, various drivers and various applications, which are loaded into the main memory 113 from the HDD 121. The CPU 111 also executes a basic input/output system (BIOS) stored in the BIOS-ROM 120. The BIOS is a program for controlling hardware.

The north bridge 112 is a bridge device that connects a local bus of the CPU 111 and the south bridge 119. The north bridge 112 incorporates a memory controller for controlling access to the main memory 113. The north bridge 112 has a function of communicating with the graphics controller 114 via an accelerated graphics port (AGP) bus and the like.

The graphics controller 114 is a display controller for controlling the LCD 17. The LCD 17 is used as a display monitor of the computer 10. The graphics controller 114 generates a video signal from the image data written to a video memory (VRAM). The video signal is sent to the LCD 17.

The south bridge 119 controls each of the devices on a low pin count (LPC) bus and a peripheral component interconnect (PCI) bus. The south bridge 119 incorporates an integrated drive electronics (IDE) controller for controlling the HDD 121 and ODD 122. The south bridge 119 has a function of controlling the digital TV broad cast tuner 123 and a function of controlling access to the BIOS-ROM 120.

The HDD 121 is a storage device for storing various types of software and data. The ODD 122 is a drive unit for driving storage media such as a DVD that stores video contents. The digital TV broadcast tuner 123 is a receiving device for receiving broadcast program data such as digital TV broadcast programs from an external device.

The EC/KBC 124 is a single-chip microcomputer on which an embedded controller for managing power and a keyboard controller for controlling the keyboard (KB) 13 and the touch pad 16 are integrated. The EC/KBC 124 has a function of powering on/powering off the computer 10 in accordance with a user's depression of the power button 14. The EC/KBC 124 also has a function of powering on the computer 10 in accordance with a user's depression of the TV start button 15A or DVD start button 15B. The network controller 125 is a communication device for communicating with an external network such as the Internet.

FIG. 3 is a block diagram showing a basic configuration for controlling a request for access to a file, which is made in the computer 10.

An OS 50, an encryption/decryption program (module) 51 and application software 52 are loaded onto the main memory 113. The CPU 111 executes these software programs to control access to the files stored in the HDD 121 and the like.

If the application software 52 issues an open request for a file stored in the HDD 121, the CPU 111 determines whether the open request is authorized in the encryption/decryption program 51 under the control of the OS 50. When the CPU 111 determines that the open request is authorized, access to (read/write of) the file is permitted.

The HDD 121 stores, for example, a data file that is encrypted and an executable file capable of executing a data file into which the encrypted data file is decrypted.

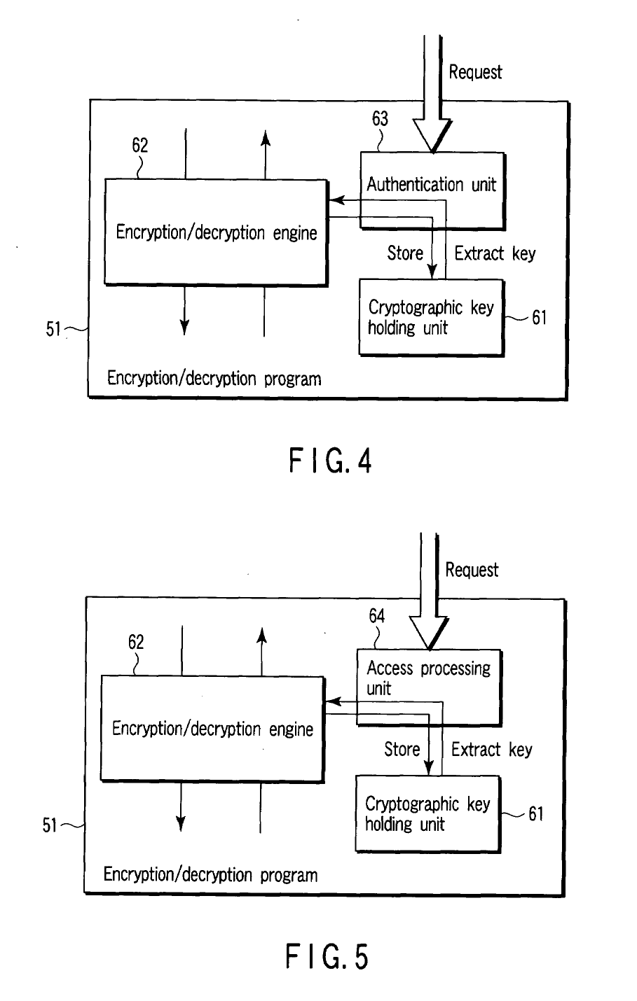

FIG. 4 is a block diagram showing a first example of the encryption/decryption program 51 shown in FIG. 3. The first example is the same as a conventional encryption/decryption program and is not necessarily adopted in the embodiment of the invention.

The encryption/decryption program 51 shown in FIG. 4 includes a cryptographic key holding unit 61, an encryption/decryption engine 62 and an authentication unit 63.

The cryptographic key holding unit 61 holds a cryptographic key, which is necessary for encrypting/decrypting a data file, for each data file. The encryption/decryption engine 62 can encrypt/decrypt a data file using its corresponding cryptographic key. The authentication unit 63 performs an authentication process (authentication of a keyword input through the keyboard, authentication using a given authentication device, confirmation as to whether a user normally logs on the OS) to determine whether a request for access issued from the application software should be permitted or not. When the request is permitted, a cryptographic key is extracted from the cryptographic key holding unit 61 and given to the encryption/decryption engine 62.

FIG. 5 is a block diagram showing a second example of the encryption/decryption program 51 shown in FIG. 3. The same components as those of FIG. 4 are denoted by the same reference numerals and their detailed descriptions are omitted.

The encryption/decryption program 51 shown in FIG. 5 does not include an authentication unit but an access processing unit 64 instead. Each time a request for access to a data file is issued, the access processing unit 64 refers to a given table and determines whether a value generated by computing information of an executable file indicated by the request for access is correct or not. When the generated value is not correct, the access processing unit 64 blocks access to the data file (e.g., the unit 64 rejects the access or provides a user with a dialogue message for urging the user to decide whether to reject the access and follows a user's instruction). On the other hand, when the value is correct, the unit 64 permits the access to the data file. In the second example, a user need not perform any authentication process at all.

The function of the authentication unit 63 shown in FIG. 4 can be incorporated in the encryption/decryption program 51 shown in FIG. 5. If it is done, the following procedure has only to be adopted. The authentication unit 63 performs an authentication process for opening a storage (any access is rejected until the storage is authenticated) and then the access processing unit 64 determines whether to block or permit a request for access (an access from an unauthorized process is blocked).

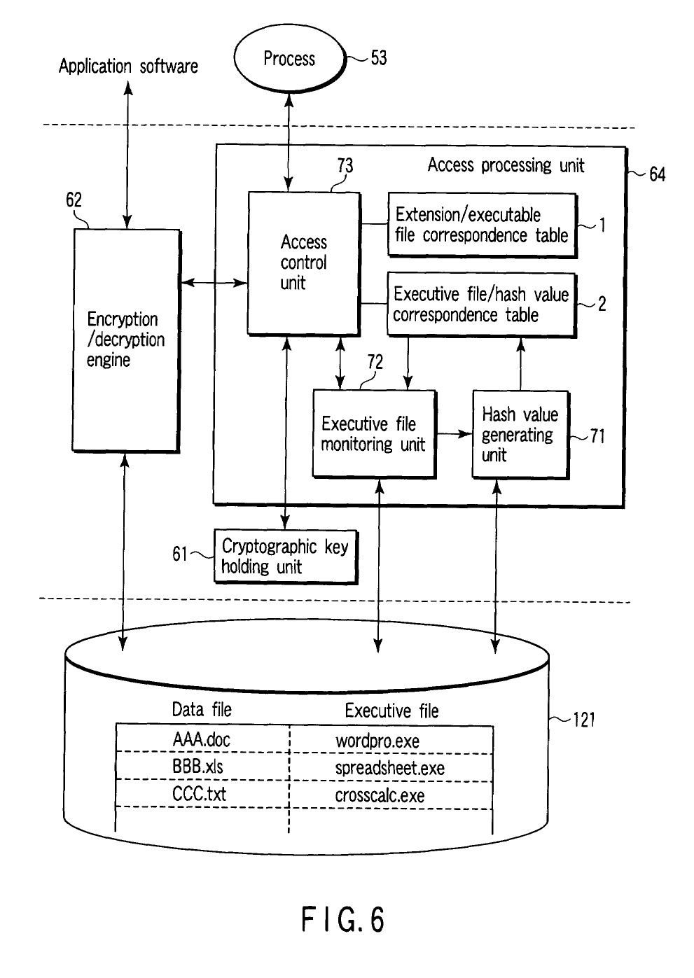

FIG. 6 is a block diagram illustrating in detail the access processing unit 64 shown in FIG. 5.

The access processing unit 64 includes an extension/executable file correspondence table (first table) 1, an executable file/hash value correspondence table (second table) 2, a hash value generation unit 71, an executable file monitoring unit 72 and an access control unit 73.

The first table 1 is an information table showing a correspondence between the extension of each individual data file stored in the HDD 121 and the names of executable files accessible to the data file.

The second table 2 is an information table showing a correspondence between the name of each individual executable file stored in the HDD 121 and the hash value generated by computing binary data of the executable file by a hash function.

The hash value generation unit 71 generates a hash value of a pseudo-random number by computing binary data of each individual executable file stored in the HDD 121 by a hash function. The generated hash value is reflected in the second table 2.

The executable file monitoring unit 72 periodically scans the executable files stored in the HDD 121 and confirms whether an executable file is rewritten on the basis of the generated hash value.

The access control unit 73 monitors the presence or absence of a request for access from a process 53 or the like. When a request for access is issued to a data file stored in the HDD 121, the unit 73 can determine whether the access is authorized or unauthorized using the functions of the table 1, table 2, executable file monitoring unit 72 and access control unit 73. For example, the hash value generation unit 71 computes binary data of an executable file indicated in a request for access from the process 53. The unit 73 determines whether a hash value generated from the binary data coincides with the computed value stored in the table 2. If they do not coincide with each other, the unit 73 can block access to the data file. In this case, the unit 73 can display information such as an alarm message on a screen through an application or the like. On the other hand, if they coincide with each other, the unit 73 can permit access to the data file (or allow decryption of the data file), and the cryptographic key in the cryptographic key holding unit 61 is given to the encryption/decryption engine 62.

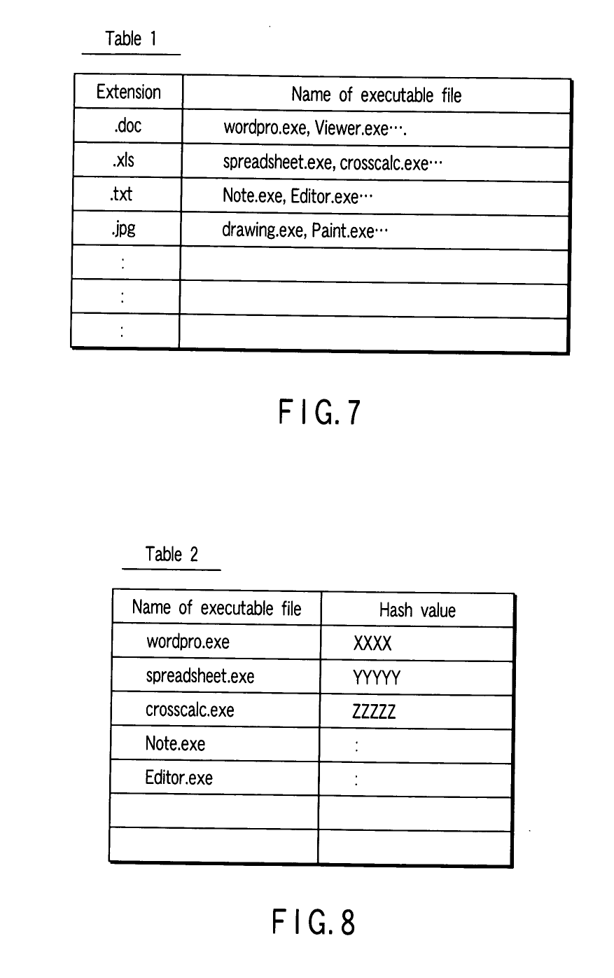

FIG. 7 is a chart showing an example of the items of the extension/executable file correspondence table (first table) 1 shown in FIG. 6.

As described above, the first table 1 shows a correspondence between the extension of each individual data file and the names of executable files accessible to the data file. With reference to the table 1, the access control unit 73 can determine whether an executable file indicated by the process 53 can gain access to a target data file.

An executable file that can gain access to a data file having an extension can be designated by a user through an application or by an IT manager through a network. The executable file can also be designated using an executable file list for opening a data file having an extension by a default since the executable file list is included in the OS.

FIG. 8 is a chart showing an example of the items of the executable file/hash value correspondence table (second table) 2 shown in FIG. 6.

As described above, the second table 2 shows a correspondence between the name of each individual executable file and the hash value generated by computing binary data of the executable file by a hash function. With reference to the second table 2, the access control unit 73 can determine whether an executable file indicated by the process 53 is authorized or not.

The hash values of executable files are generated first in a safe state (e.g., when a user starts to use the computer 10). When a file is updated, a hash value is generated again (by user's instruction). Even though a request for access is issued to a file in the table from an executable file that is updated without user's consciousness, the access will be rejected. When an IT manager distributes the executable files to the respective users (while inhibiting the users from generating hash values again), he or she can distribute the generated hash values to the users at the same time. The executable file that is not authorized by the IT manager can be prevented from gaining access to a data file.

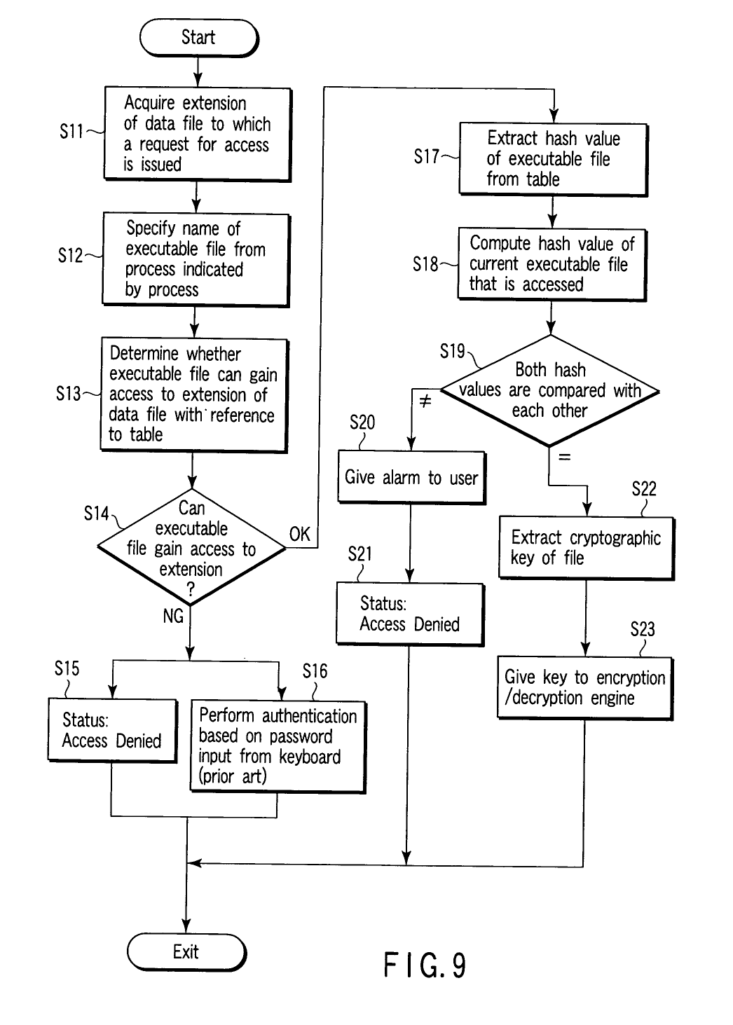

An operation of the access processing unit 64 shown in FIG. 6 will be described with reference to the flow chart shown in FIG. 9.

Upon receiving a request for access to a data file from the process 53, the access processing unit 64 acquires the extension of the data file (block S11). The unit 64 specifies the name of an executable file indicated by the process 53 (block S12). With reference to the table 1, the unit 64 determines whether the executable file can gain access to the data file (block S13).

When the access processing unit 64 determines that the executable file cannot gain access to the data file (NG in block S14), a user's selected one of two processes is performed. One of the processes is a process of rejecting the access to the data file as an error without fail when the executable file cannot gain access to the data file (block S15). The other is a process of determining whether the executable file can gain access to the data file by authentication based on a password input through the keyboard as in the prior art (block S16). The prior art authentication is performed only at the time of access that is not usually gained, such as copying of data files in external media and attachment of data files to email. If, therefore, an unintended request for authentication is made, a user can detect access from a program that is not recognized by the user, such as spyware.

When the access processing unit 64 determines that the executable file can gain access to the data file (OK in block S14), the hash value of an executable file on the second table 2 is extracted (block S17), and the hash value of an executable file corresponding to the request for access is generated (block S18). Both the hash values are compared with each other (block S19).

When the hash values do not coincide with each other, the alarm is given to a user (block S20) and the access is rejected (block S21). When the hash values coincide with each other, the cryptographic key of the data file is extracted from the cryptographic key holding unit 61 (block S22) and given to the encryption/decryption engine 62 (block S23).

According to the embodiment of the invention, spyware and external hacking (through a fire wall and a shared hole of a storage) can be prevented with reliability. Since the access processing unit of the embodiment is incorporated into a module for encrypting/decrypting a data file, it can gain access to plain-text data into which an encrypted file in the storage is decrypted in a process permits access thereto, and access to the plain-text data from unauthorized process can be rejected (even though encrypted data is stolen, the resistance to attack upon the encryption logic adopted in an encrypted storage is secured).

The processes of the embodiment according to the invention can be stored in computer-readable storage medium (magnetic disk, optical disk, semiconductor memory, etc.) as computer programs, and read and executed by a processor when the need arises. The computer programs can be transmitted and distributed from a computer to another computer via communication medium.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a storage unit which stores an encrypted data file and an executable file to execute the data file;
a processing unit which stores a value generated by computing information of the executable file in a storage area; and
a control unit which determines whether a value generated by computing information of an executable file indicated by a request for access to the data file stored in the storage unit coincides with the value stored in the storage area, and blocks access to the data file when both the values do not coincide with each other.

2. The information processing apparatus according to claim 1, wherein the control unit permits the data file to be decrypted when both the values coincide with each other.

3. The information processing apparatus according to claim 1, further comprising:
a cryptographic key holding unit which holds a cryptographic key necessary for encrypting/decrypting the data file; and
an encryption/decryption unit which encrypts/decrypts the data file using the cryptographic key, and
wherein the control unit permits access to the data file when both the values coincide with each other and gives the cryptographic key to the encryption/decryption unit.

4. The information processing apparatus according to claim 1, wherein the control unit generates alarm information when both the values do not coincide with each other.

5. The information processing apparatus according to claim 1, the generated value is a hash value obtained from a hash function.

6. An access control method applied to an information processing apparatus including a storage unit which stores an encrypted data file and an executable file to execute the data file, the method comprising:
storing a value generated by computing information of the executable file in a storage area; and
determining whether a value generated by computing information of an executable file indicated by a request for access to the data file stored in the storage unit coincides with the value stored in the storage area, and blocking access to the data file when both the values do not coincide with each other.

7. The access control method according to claim 6, further comprising permitting the data file to be decrypted when both the values coincide with each other.

8. The access control method according to claim 6, further comprising:
holding a cryptographic key necessary for encrypting/decrypting the data file; and
permitting access to the data file when both the values coincide with each other, and encrypting/decrypting the data file using the cryptographic key.

9. The access control method according to claim 6, further comprising generating alarm information when both the values do not coincide with each other.

10. The access control method according to claim 6, the generated value is a hash value obtained from a hash function.

11. A storage medium storing computer-executable program code executed by a processor for performing control of an access in an information processing apparatus including a storage unit which stores an encrypted data file and an executable file to execute the data file, the program code comprising:
code to store a value generated by computing information of the executable file in a storage area; and
code to determine whether a value generated by computing information of an executable file indicated by a request for access to the data file stored in the storage unit coincides with the value stored in the storage area, and blocking access to the data file when both the values do not coincide with each other.
